(19) United States
(12) Patent Application Publication
(10) Pub. No.: US 2003/0067537 A1
(43) Pub. Date: Apr. 10, 2003

(54) System and method for three-dimensional data acquisition

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(21) Appl. No.: 09/987,336

(22) Filed: Nov. 14, 2001

Related U.S. Application Data
(63) Continuation-in-part of application No. 09/969,583, filed on Oct. 4, 2001.

(51) Int. Cl. H04N 13/02

(52) U.S. Cl. 348/47; 348/42; 348/169

(57) ABSTRACT

At least one two-dimensional grid is projected onto a three-dimensional subject in order to determine or represent contours of the subject based on distortion of the grid. Each grid has a wavelength or range of wavelengths that is different than those of every other grid, and different than a wavelength or range of wavelengths of light used to illuminate the subject, permitting optical separation of the grids during capture of the image of the subject. Range finding and/or scaling may be accomplished by alignment of multiple grids, or by using a ladar (laser radar) or similar range finder to determine the distance to a predetermined point or feature on at least one of the grids.

This application is a continuation-in-part of copending U.S. patent application Ser. No. 09/969,583, filed Oct. 4, 2001.

### BACKGROUND OF THE INVENTION

1. Field of the Invention

This invention relates to a system and method for capturing stereoscopic images and related data in a format that facilitates interpretation of the images and data by a human viewer or processing by a computer or other electronic processing device.

The invention involves projecting one or more optical grids or other patterns onto the subject, the projected grid(s) or pattern(s) reflecting contours of the subject. The subject may be illuminated by any type of illumination, including visible light, so long as the resulting image of the subject can be distinguished from the image or images of the grid or grids (or other patterns, hereinafter referred-to simply as “grids”).

Preferably, the wavelengths or frequencies of light used to form the guide or patterns are different than the wavelengths or frequencies of light used to illuminate the subject and, in applications involving multiple grids, different from each other. This permits optical separation by using one or more beam splitters that transmit or reflect the respective images of the grid or grids and of the subject to different detectors that capture the separated images for display or analysis.

The more rapid processing of three-dimensional information that results from optical separation of the grids reduces data processing requirements sufficiently to enable processing of the grids or patterns to take the place of more rapid data sampling or gating in laser radar and other range finding or three-dimensional mapping systems, including conventional radar and sonar systems. Instead of sampling each point or “pixel” of a surface to be mapped by the ladar radar or similar system, it is only necessary to sample as few as one point or pixel corresponding to a distinct feature of the projected grid or pattern, such as an intersection of lines, the remainder of the points or pixels being “sampled” by analyzing the reflected grid or pattern.

More specifically, the invention has the following aspects:

a. Projection of a two-dimensional grid onto a three-dimensional subject in order to determine contours of the subject based on distortion of the grid;

b. Projection of multiple two-dimensional grids onto the subject in order enable stereoscopic rendering or analysis of the subject without the need for stereoscopic camera arrangements or scanning;

c. Use of infrared, multi-spectrum, or specific frequency light waves to form the grid(s) in a way that permits the grids to easily be distinguished from a composite image of the subject and grid(s);

d. Use of grids having different frequencies or frequency spectra so that multiple grids may more easily be distinguished from each other;

e. Optical separation of the grid or grids from the composite image so as to facilitate interpretation of the images and data by a human viewer or processing by a computer or other electronic processing device;

f. Optical separation of multiple grids from each other so as to facilitate interpretation of the images and data by a human viewer or processing by a computer or other electronic processing device;

g. Use of a beam splitter to extract the grids from a visible light portion of the composite image of the subject;

h. Use of a beam splitter to distinguish the two grids;

i. Range finding by alignment of features associated with multiple grids;

j. Facilitating range finding, mapping, targeting, tracking, and other advanced three or higher dimensional data acquisition functions by utilizing the system and method of the invention in connection with a laser radar (ladar) system; and

k. Use of the separated images of the subject and the lines of the grid, according to features a-j, for any of a variety of purposes, including generation of three-dimensional representations of the subject, detection, analysis, or tracking of subject movements, detection of flaws in the subject, subject identification or recognition including fingerprint identification and facial recognition, targeting or range finding with respect to fixed or moving subjects, guidance of missiles, robotic systems, and other moving objects, facilitating night vision, air traffic control, tracking of undersea objects such as fish or submarines, and so forth.

Among the numerous advantages of the invention are simplification of hardware by, for example, eliminating or reducing the need for scanning, and simplification of software by eliminating the need for feature analysis or pattern matching in order to distinguish the grid lines or contours.

2. Description of Related Art

The ability to rapidly capture or render three-dimensional images of a subject so as to track movements of the subject, and/or to draw the subject as it moves, has been a goal of computer programmers for many years. One of the initial applications for three-dimensional image capture and processing was to detect defects in the surfaces of manufactured items. More recently, proposals have been made to use three-dimensional image input systems and methods to control computers based on hand or eye movements, to insert images of persons into video games, to track movements of the subject to analyze the movements or so that the subject can interact with the video game or other virtual reality program, identify fingerprints or recognize persons based on their profiles, and/or for use in domestic security, air traffic control, or defense-related tracking, targeting, intelligence gathering, and guidance systems.

All of these applications require substantial processor resources, and even the simplest such systems tend to stretch the limits of currently available computer systems. The technology for utilizing three-dimensional data input is developing rapidly, but commercialization of the technology has been limited by either (i) the cost and complexity of current data input hardware and control software, or (ii) if simpler input means are used, the cost and complexity of image processing software necessary to make sense of the data. The present invention seeks to simplify both image capture hardware and the image processing software necessary to enable a projected grid to be captured, displayed, and/or analyzed.

To accomplish this, the present invention enables input of a reference grid that captures the contours of the subject, and yet that can be separated from the image of the subject by using a grid formed by light having a frequency different than that used to illuminate the subject on which the grid is superimposed, and by using simple optical means such as beam splitters to capture an electronic image of the grid that can be processed without the need to electronically separate it from its background. The contours represented by the optically separated grid can then be displayed without further electronic processing, or analyzed using relatively simple numerical analysis rather than more difficult qualitative analysis. While systems and methods that utilize grid projection are known, most rely on electronic processing techniques, and none simplifies processing as much as the present invention.

The following references illustrate general principles of three-dimensional imaging, measurement or mapping of three-dimensional surfaces using scanners, tracking of moving objects in three-dimensions, and/or stereoscopic image processing and analysis, but fail to show either the grid projection or image separation aspects of the present invention:

With respect to the grid projection aspect of the invention, U.S. Pat. No. 6,252,623 discloses imposing a three-color grid pattern on a subject, but the grid is created by projecting visible light through a color grating, which makes it difficult to distinguish the grid in the presence of background visible light, and separating the colors of the one-dimensional grid electronically rather than optically based on pixels activated by the CCD.

U.S. Pat. No. 6,205,243 discloses a system that projects laser scan lines onto a subject with sufficient rapidity to form a “mesh” in the composite image that can be used to determine surface contours. However, the use of laser scanning in the system of this patent makes the system much more complicated than is the case with a system that uses multiple light frequencies to distinguish an image of a subject from one or more reference grids projected onto the subject.

U.S. Pat. No. 5,982,352 discloses use of grid distortion to indicate the location and force of contact between a user and a surface, such as a touch screen surface or the floor. In several examples, the grid is projected onto the surface and captured by a “tv camera” connected to a computer, but there is no provision for use of multiple light frequencies to distinguish an image of the subject from the reference grid, or for optical separation so the grid from a composite image of the subject and grid.

Finally, with respect to the grid projection aspect of the invention, U.S. Pat. No. 6,191,850 discloses projection of a grid pattern onto an object of manufacture for the purpose of detecting surface defects, but there is again no provision for use of multiple light frequencies to distinguish an image of the subject from the reference grid, or for optical separation so the grid from a composite image of the subject and grid.

With respect to the optical separation or beam splitter aspect of the invention, U.S. Pat. No. 5,910,816 discloses the use of dichroic beam splitters to separate visible and infrared components of an image, but there is no way to separate infrared components from each other, and the infrared components do not represent a grid or other pattern projected onto the subject.

By way of background, numerous references disclose generation of a three-dimensional representation of a subject by utilizing scanning and/or complex image processing that does not rely on reference grids. For example, FIG. 3 of U.S. Pat. No. 5,531,520 shows “striping” created by processing data generated by a laser scanner. The striping is overlaid over an image of a or tumor for the purpose of assisting a surgeon in locating the tumor.

Similar laser scanning systems, for analyzing objects in a manufacturing setting, are disclosed in U.S. Pat. Nos. 4,628,469 and 4,498,778.

U.S. Pat. No. 5,129,010 discloses use of “infrared laser slit light” for the purpose of determining the flushness of an automobile assembly, but the “slit light” is scanned and does not form a grid, while U.S. Pat. Nos. 5,280,542 and 4,600,012 disclose similar systems utilizing non-infrared pulsed slit lines.

U.S. Pat. No. 4,914,460 discloses projection of a laser grid in the form of linear series of discrete spots onto an object, but only for the purpose of determining position and orientation of a submarine object.

U.S. Pat. Nos. 6,009,210 and 6,215,471 disclose a purely electronic computer input device which tracks a face by comparing an image of the face with reference images representing different positions, while U.S. Pat. No. 6,215,471 tracks a face by tracking movement of “landmarks” on the face, and U.S. Pat. No. 5,767,842 discloses a similar system for fingers.

The concept of using three-dimensional object sensing as a computer input means is also disclosed in U.S. Pat. No. 5,900,863, but the object sensing is either based on parallax range finding, or on determining object parameters by determining which of an array of light beams is reflected (or blocked) by the object. A more sophisticated and complex version of a computer input that employs object detection by pixel-analysis input device is disclosed in U.S. Pat. No. 6,144,366.

U.S. Pat. Nos. 6,002,808 and 6,222,465 disclose a respective “hand gesture control” and “video gesture recognition” system in which images of a hand are electronically analyzed to detect movement.

U.S. Pat. No. 5,235,416 discloses use of two cameras sensitive to different wavelengths, and two corresponding illumination sources to simultaneously image two sides of an object without interference, but does not disclose any sort of grid.

U.S. Pat. No. 5,528,263 discloses a system in which a grid is projected onto a two-dimensional projection screen to enable location of a pointer, rather than being projected onto a three-dimensional surface to indicate contours of the surface.

Finally, U.S. Pat. No. 4,499,492 is representative of a number of patents disclosing “range imaging employing parallax” which utilizes scanning to determine the distance to a selected point on an object. U.S. Pat. No. 6,198,485 discloses using such a range finding system to track a marker placed on a finger.

Similar “ladar” systems that use laser radar to acquire data on three-dimensional subjects for mapping, target acquisition, and similar applications, both civilian and military, are also disclosed in a paper entitled “Ladar systems for 3D measuring applications,” available on the Internet at “laseroptronic.com.” This paper describes a number of applications for 3D laser radar scanner units capable of measuring and storing up to 50,000 3D points/sec., but with no suggestion that projected optical grids can be used in connection with the radar scanner units to greatly increase data acquisition speeds or efficiency.

### SUMMARY OF THE INVENTION

It is accordingly a first objective of the invention to provide a simple and inexpensive system and method for capturing stereoscopic images and related data in a format that facilitates interpretation of the images and data by a human viewer or processing by a computer or other electronic processing device

It is a second objective of the invention to provide a system and method for capturing stereoscopic images and related data in a format that facilitates processing by a computer or other electronic processing device in a way that eliminates the need for feature extraction, interpolation, and other complex image processing software or algorithms.

It is a third objective of the invention to provide a system and method for capturing stereoscopic images and related data in a format that facilitates interpretation of the images and data by a human viewer or processing by a computer or other electronic processing device, and which does not require complex scanning hardware or software but rather may use ordinary fixed cameras or other viewing or image capture devices, and conventional light sources.

It is a fourth objective of the invention to provide a system and method for capturing contours of a three-dimensional subject that permits the contours to be captured and displayed without any further electronic processing.

It is a fifth objective of the invention to provide a system and method for capturing contours of a three-dimensional subject that enables correlation of superposed grid lines and a visible light image of the subject, while permitting direct analysis of the grid lines without the need for electronically separating the grid lines from the visible light image of the subject.

It is a sixth objective of the invention to provide a system and method for acquiring data concerning three-dimensional objects that provides range-related data as well as profile data.

It is a seventh objective of the invention to provide a system and method for acquiring data concerning three-dimensional objects that enables sampling or gating of as few as one pixel in a scanned image without loss of resolution.

It is a eighth objective of the invention to provide a ladar mapping, tracking, guidance, or target acquisition system having increased speed and accuracy without substantially increased complexity.

It is an ninth objective of the invention to provide a three-dimensional imaging system useful for guidance, tracking, target acquisition, and other similar applications, and that has reduced vulnerability to bloom, blinding, and deflection techniques.

It is a tenth objective of the invention to provide a three-dimensional imaging system that can track specific temperatures and shapes in a wide variety of environments, including at night and underwater, and that can relatively easily be configured to accomplish detailed analysis of subjects on scales ranging from microscopic to planetary.

These objectives are accomplished, in accordance with the principles of a preferred embodiment of the invention, by providing a system and method for capturing contours of a three-dimensional subject, and/or acquiring data correlated with three-dimensional geometric features of the subject, in which a two-dimensional grid is projected onto the three-dimensional subject and distortion of the grid reflective of subject contours is captured and, subsequently, optically separated from the composite image of the subject and grid for viewing or further processing.

The objectives of the invention are further accomplished by providing a system and method for capturing contours, and/or data correlated with contours, of a three-dimensional subject in which multiple two-dimensional grids are projected onto the subject in order to enable stereoscopic rendering or display of the subject without the need for stereoscopic camera arrangements or scanning.

The objectives of the invention are still further accomplished by providing a system and method for capturing contours of a three-dimensional subject, or related data, which uses infrared light to form at least one grid so as to easily distinguish the at least one grid from a composite image of the subject and grid, and which in the case where multiple grids are used to achieve a stereoscopic effect without the need for multiple cameras, uses different infrared frequencies so that the multiple grids may more easily be distinguished from each other.

The objectives of the invention are also accomplished by providing a system and method for capturing contours of a three-dimensional subject or related data, which uses optical separation of a grid from the composite image so as to simplify electronic processing, and which in the case where multiple grids are used to achieve a stereoscopic effect without the need for multiple cameras situated at different angles, uses optical separation of the multiple grids from each other so as to further simplify subsequent electronic processing.

The objectives of the invention are further accomplished by providing a system and method for capturing contours of a three-dimensional subject, or related data, which uses a beam splitter to extract the grids from the visible light portion of the composite image of the subject, and a beam splitter to distinguish the grids from each other. Alternatively, separate images of the grids may be obtained through the use of discrete image capture devices or media sensitive to wavelengths or frequencies corresponding to those of one grid but not the other grid.

Those skilled in the art will appreciate that the three-dimensional data that may be acquired by the method and apparatus of the invention includes, but is not limited to, data related to geometry, distance, texture, velocity, temperature, and scale. In addition, those skilled in the art will appreciate that any of the above-described aspects or embodiments of the invention may be used in connection with any of the applications of three-dimensional imaging noted above, including generation of a three-dimensional representation of a subject, detection or analysis of subject movements, detection of flaws in the subject, subject identification or recognition, and targeting or range finding.

For example, in addition to three-dimensional rendering applications, the invention may be used to scan crowds on airplanes or in airports in order to pick out potential terrorist suspects or activity, either based on movement tracking, feature recognition, or by scanning for weapons or suspicious objects held by the potential terrorist. Alternatively, on a larger scale, the invention may be used to track or target aircraft, or to detect cloud formations from satellites or, on a smaller scale, to scan fingerprints.

To this end, the invention is not to be limited to capture of grids by a particular camera or detector arrangement or type, to particular numbers, arrangements, or types of projection equipment, or to grids having a particular frequency or range of frequencies. Either the grid projectors or the detectors may be fixed or movable, each grid may be captured by one or more detectors, and each detector may be arranged to capture one or more grids. Furthermore, in certain circumstances, the “grids” may be in the form of patterns other than grids made up of mutually perpendicular sets of lines, or may be collapsed into one-dimensional lines captured by separate detectors and combined following detection, and the grids may be projected in combination with other types of indicia such as hash marks used for targeting or range finding.

Range finding may be achieved either by aligning hash marks on multiple grids in the manner of a conventional photographic camera viewfinder, or by projecting one or grids onto a subject and scanning the subject with a ladar radar (ladar) device. When combined with a ladar or other range finding device, such as conventional radar or sonar, the use of projected grids or patterns greatly reduces the sampling or gating frequency necessary to scan the subject for mapping, tracking, guidance, or target data acquisition by permitting the range finding beam to be focused on a single point on the grid, or a discrete number of points.

### BRIEF DESCRIPTION OF THE DRAWINGS

FIG. 1 is a side view of a subject illuminated by a single infrared grid projection system constructed in accordance with the principles of a preferred embodiment of the invention.

FIG. 2 is a side view illustrating the use of multiple projection systems to complete a 360° view of the subject.

FIG. 3 is a front view of the subject illustrated in FIG. 1.

FIG. 4 is a perspective view showing grid distortion along contours of the subject illustrated in FIG. 1.

FIG. 5 illustrates a captured image taken in the presence of visible light and containing two infrared grids projected from different angles, together with the results of wavelength separation of the composite image into separate images of the two infrared grids and a visible image of the subject.

FIGS. 6 and 7 illustrate filtering apparatus utilized by the preferred embodiment of the invention.

FIG. 8 is a schematic illustration showing use of the invention for range finding.

FIG. 9 is a schematic illustration showing a complete imaging system utilizing a stereoscopic arrangement corresponding to the arrangement shown in FIG. 5.

FIGS. 10-13 are schematic diagrams of various airplane and airport security applications for the method and apparatus of the invention.

FIG. 14 is a schematic diagram of a tracking or targeting system that utilizes the principles of the invention.

FIG. 15 is a schematic diagram of a satellite based system utilizing the principles of the invention.

FIG. 16 is a schematic diagram of a ladar mapping system that also utilizes the principles of the invention.

### DETAILED DESCRIPTION OF THE PREFERRED EMBODIMENTS

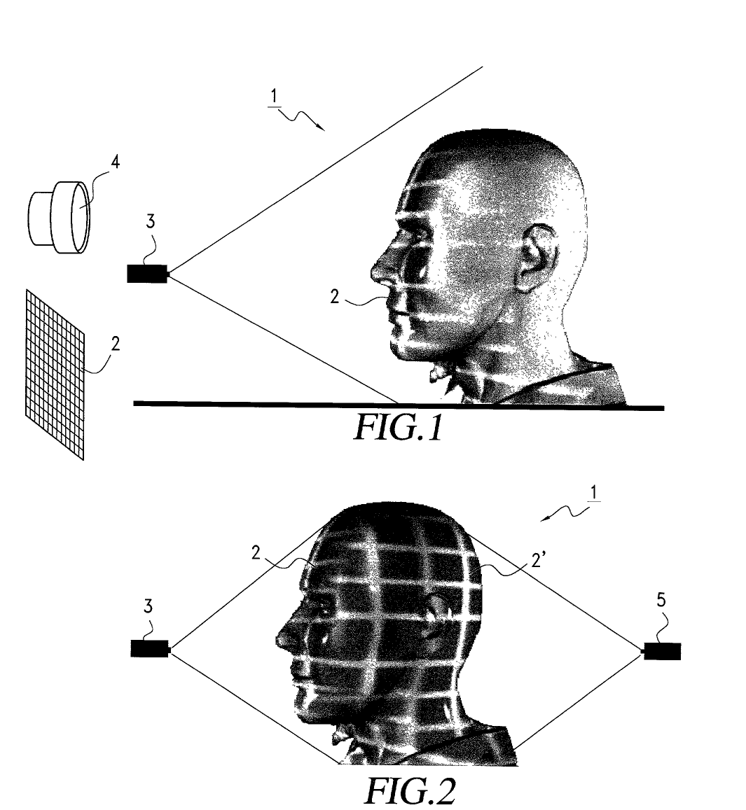

FIG. 1 illustrates an embodiment of the invention in which the subject 1 is illuminated by a single infrared grid 2 projected from the front of the subject by a projector 3. The subject 1 may also be illuminated by a substantially uniform light source 4, by multiple light sources, or by ambient light.

In a variation of the embodiment of FIG. 1, multiple grids 2 and 2′ may be projected onto the subject in order to enable capture of contours for the entire 360° of the subject by using an additional camera 5 (or, equivalently, by moving projector 3 around the subject), as illustrated in FIG. 2.

Each grid shown in FIGS. 1 and 2 is preferably an infrared grid having a wavelength of sufficient intensity to enable an image of the grid to be captured despite background infrared radiation that might be emitted by the subject, and is made up of mutually perpendicular horizontal and vertical lines. Suitable infrared light sources are well-known, as are cameras and film capable of capturing infrared light. The projectors 3 and 5 may be simple lamp and mask arrangements in which the lamp is arranged to illuminate the subject through a mask having openings in the shape of a grid, or an arrangement in which the lamp is reflected by a grid-shaped reflector, although the invention is not to be limited to such lamp and mask or reflector arrangements.

Light source 4 may be a visible, infrared, or ultraviolet light source for enabling the camera to capture features of the subject other than the contours reflected in the captured grid. According to the principles of the invention, the exact wavelength or wavelengths of light source 4 may be freely varied to meet requirements of the application in which the invention is used, except that the wavelength or wavelengths emitted by the light source 4 must be different than those emitted by projector 3. As explained below, use of different wavelengths to illuminate the subject as a whole than are used for the grid makes it possible to more easily separate the image of the grid from that of the subject.

It may, in some circumstances, be useful simply to capture an image of the infrared grid without illumination of the entire subject, in which case lamp 4 may be omitted. On the other hand, a significant advantage of the invention is that it permits a visible, ultraviolet, or infrared light image of the subject to be captured with the grid superposed so that aspects of the subject such as coloring, and also details of physical features smaller than the smallest grid unit, can be captured and located with reference to the grid.

Although infrared light is preferred for many applications, the principles of the invention are not limited to infrared grids, or to grids having a specific frequency. In some applications, it may be desirable to use multi-spectrum waves, enabling the penetration of current guidance defense techniques and/or to increase effectiveness over the widest variety of environmental conditions. The only requirements are that the light used to illuminate the subject, and the light projected to form each grid, be of different frequencies or ranges of frequencies so as to enable separation by beam splitters having appropriate bandwidths.

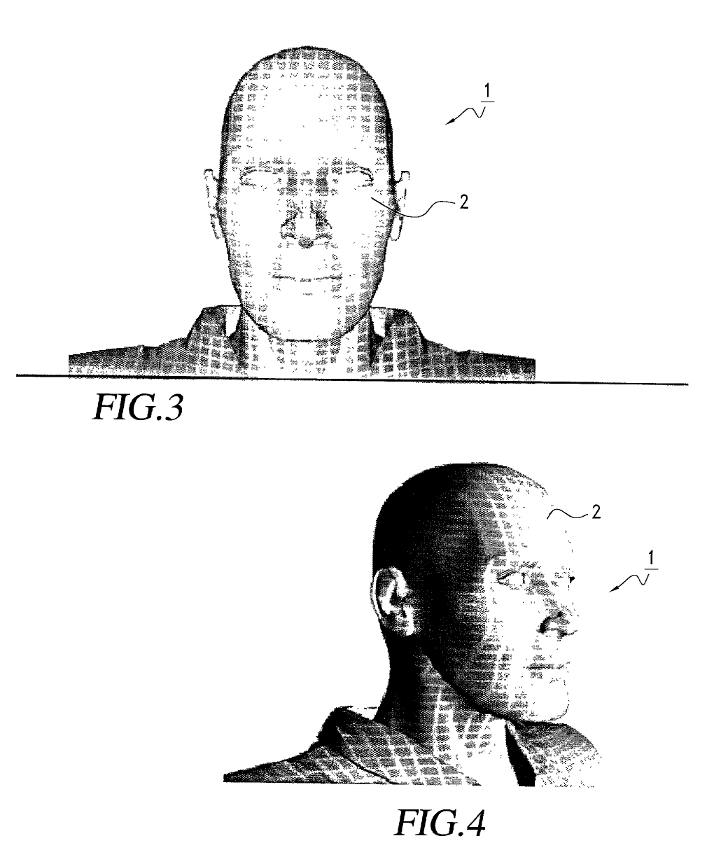

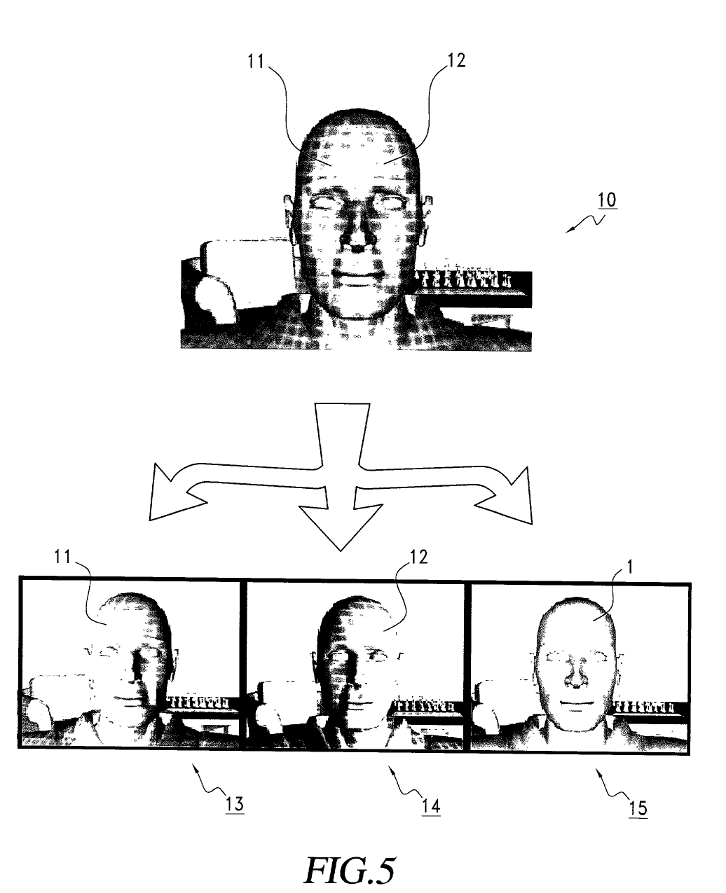

As illustrated in FIG. 3, the use of a single grid 2, or corresponding single grids 2 and 3 projected onto the front and back of the subject, does not by itself permit contours of the subject to be determined. Instead, contours of the subject are only revealed by capturing the image at an angle relative to the side of the subject whose contours are to be captured or analyzed, as illustrated in FIG. 4. By using two cameras on each side of the projector, a stereoscopic view can be captured using a single grid.

In order to avoid the need to capture two images of the subject, however, it is also possible to create a stereoscopic effect by orienting the projectors at angles relative to the subject, and positioning the camera midway between the projectors, as illustrated in FIG. 5. Image 10 in FIG. 5 is a front view of the subject onto which has been projected two infrared grids 11 and 12 using two projectors (not shown) of the type illustrated in FIG. 2, oriented at equal angles on each side of the camera or image capture apparatus. According to the principles of the invention, the composite image 10 consists of, and may be separated into, three constituent images: (i) an image 13 of the first grid 11, (ii) an image 14 of the second grid 12, (iii) a image 15 of the subject without the grids. Although images 13 and 14 show the subject and background, the subject and background can be made to disappear by selecting appropriate grid wavelengths and bandwidths of the filters or beam splitters used to separate the images, leaving only images of the respective grids. Of course, by adding one or more cameras and projectors to the arrangement illustrated in FIG. 5, or by moving the cameras and projectors of FIG. 5 around the subject, it is possible to capture a 360° view of the subject.

Separation of image 15 from images 13 and 14 is accomplished, as described above, by using different wavelengths for image 15 and the grids in images 13 and 14. In addition, the left and right grids in images 13 and 14 are preferably also projected using light sources of different frequency.

Image processing techniques for generating a three-dimensional image of a subject based on contours are well-known and need not be described in detail herein. However, image processing is uniquely facilitated in the system and method of the present invention by including a filtering device 20 that optically, rather than electronically, separates the one or more infrared grids from the visible light image. This device may be used to separate light reflected directly from the subject, in lieu of a camera, or may be used to process a recorded image or slide, or an image of the subject displayed on a CRT, LCD, or the like.

The filter device 20 includes a pair of beam splitters 21 and 22, one of which is arranged to separate the infrared light of the grid from the light used to illuminate the subject, which may be visible light, and the other of which is arranged to separate infrared light of different frequencies. The first beam splitter transmits the image of the subject to a detector A while reflecting the infrared light images of the two grids. The second beam splitter separates the infrared light images of the two grids into separate images of the respective grids by transmitting one frequency of infrared light to a detector B and the other frequency of infrared light to a detector C for separate, simplified processing.

In the variation illustrated in FIG. 7, device 25 includes beam splitters 26 and 27 arranged to separate light of different frequencies in the same manner as beam splitters 21 and 22, except that the image of the subject is reflected rather than transmitted to detector A, and the image of the first grid is reflected rather than transmitted to detector B.

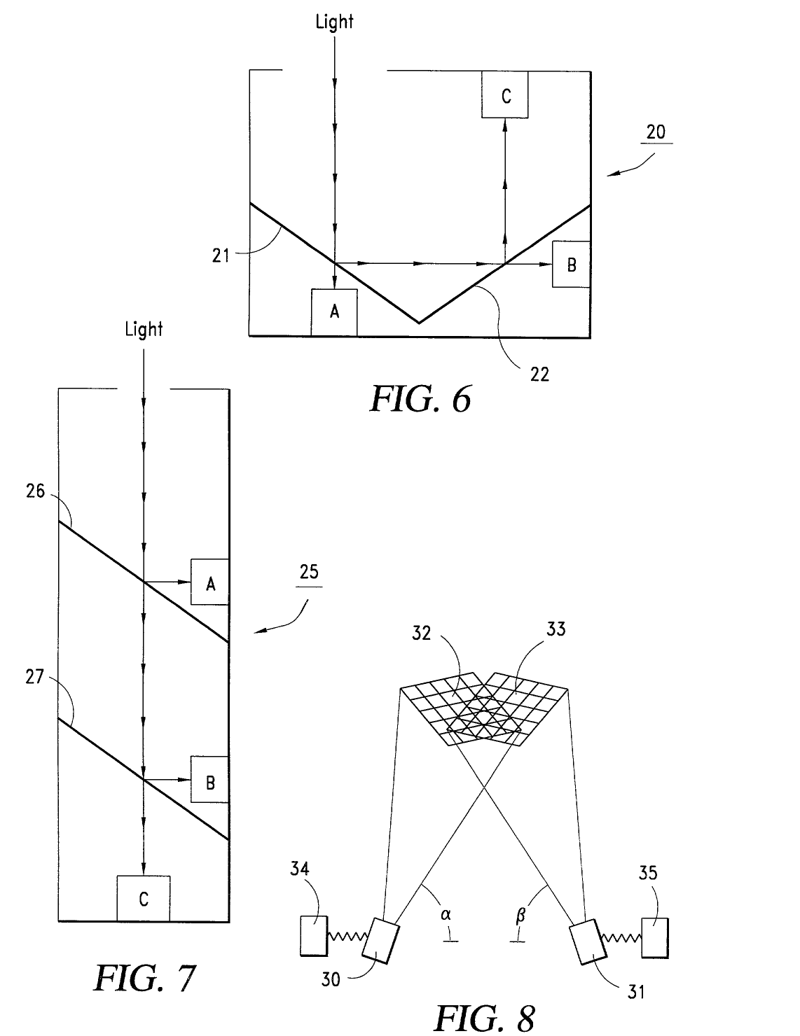

It will be appreciated by those skilled in the art that suitable beam splitters are well-known and readily available or manufacturable. In addition, the beam splitters may be replaced by other filter arrangements, such as an arrangement in which the composite image is filtered by parallel filters for the three frequencies, rather than series arrangements illustrated in FIGS. 6 and 7, i.e., the composite image duplicated twice and directed to separate filters for transmission of the respective images. Alternatively, the filter arrangements may be replaced by image capture devices or media sensitive to the wavelength or frequency of one of the respective grids, but not to the wavelength or frequency of the other grid or of the background illumination.

In the embodiment illustrated in FIG. 8, two projectors 30 and 31 are aimed at a subject (not shown) with the objective of creating a set of stereoscopic profiles corresponding to those illustrated in FIG. 5. However, the arrangement of this embodiment has the added feature that the azimuth of the projectors may be adjusted by mechanisms 34 and 35 so that the grids can be positioned on subjects at various distances from the projector. In that case, the azimuth angles α and β of the detectors when the grids overlap, i.e., upon alignment of corresponding hash marks, will give the relative angles and distance from the projectors to the subject. Those skilled in the art will appreciate that rather than adjusting the azimuth of at least one of the receivers, it is also possible to track an object by monitoring grids projected at a fixed angle, the distance to the subject being known when landmarks on the reflected grids coincide.

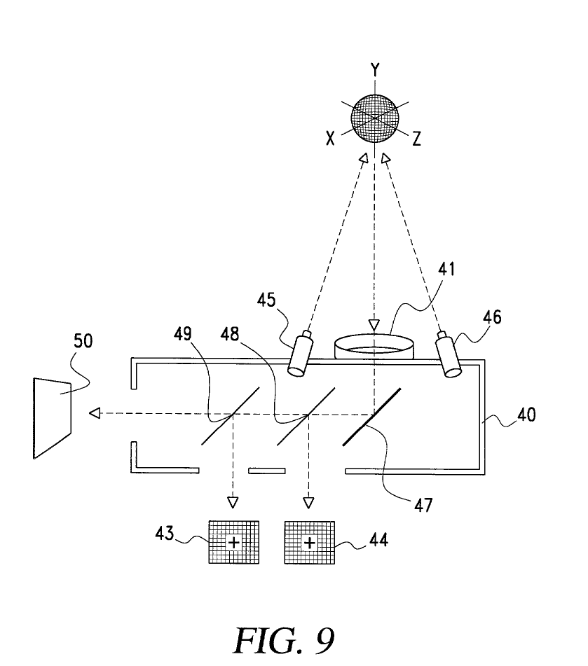

In the embodiment illustrated in FIG. 9, the projectors and receiver are combined to form a digital imaging camera 40 having a lens 41 for focusing the image of the subject 42 and corresponding reflected grids 43,44 projected by respective left and right projectors 45,46. The grids have hash marks to enable range finding as described above in connection with FIG. 8, and are reflected by mirror 47 to a pair of beam splitters 48,49 that separate the grids and output an image 50 to a viewer or imaging device such as a CCD.

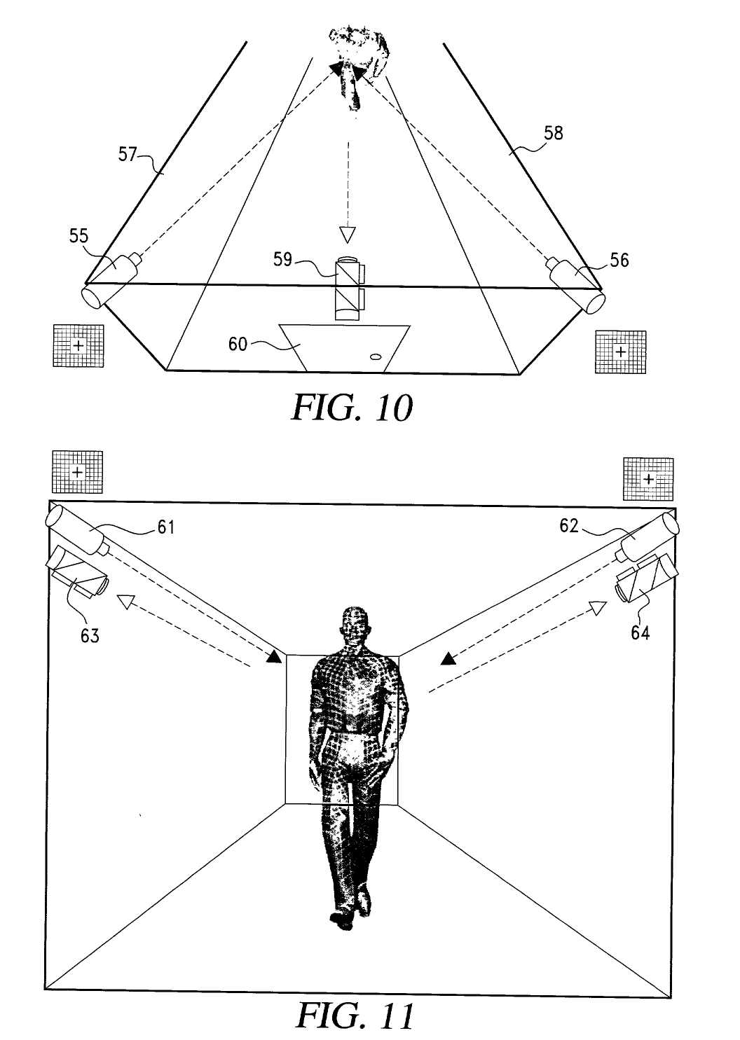

Although the invention is suitable for applications too numerous to specify, one application for which there is an especially urgent need is airport security. In the arrangement illustrated in FIG. 10, projectors 55 and 56 are hidden in the walls 57,58 of an airport corridor and a receiver 59 corresponding to the one illustrated in FIG. 9 is hidden above a doorway or entrance 60 in order to capture stereoscopic images or image data for analysis by pattern matching, curve fitting, or other well-known data processing techniques. Alternatively, as illustrated in FIG. 11, projectors 61,62 may be associated with separate receivers 63,64, each including a single beam splitter or other image capture device sensitive to the wavelength or frequency of a corresponding grid.

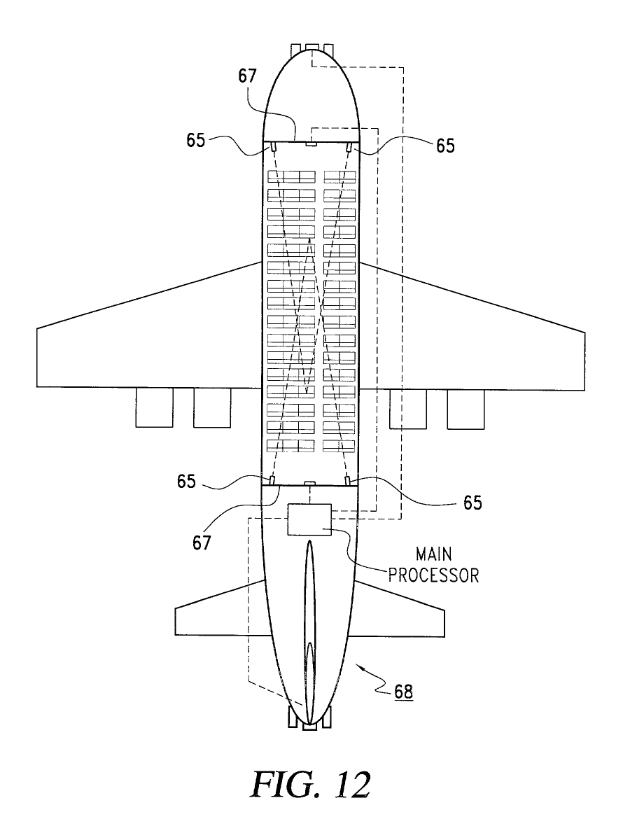

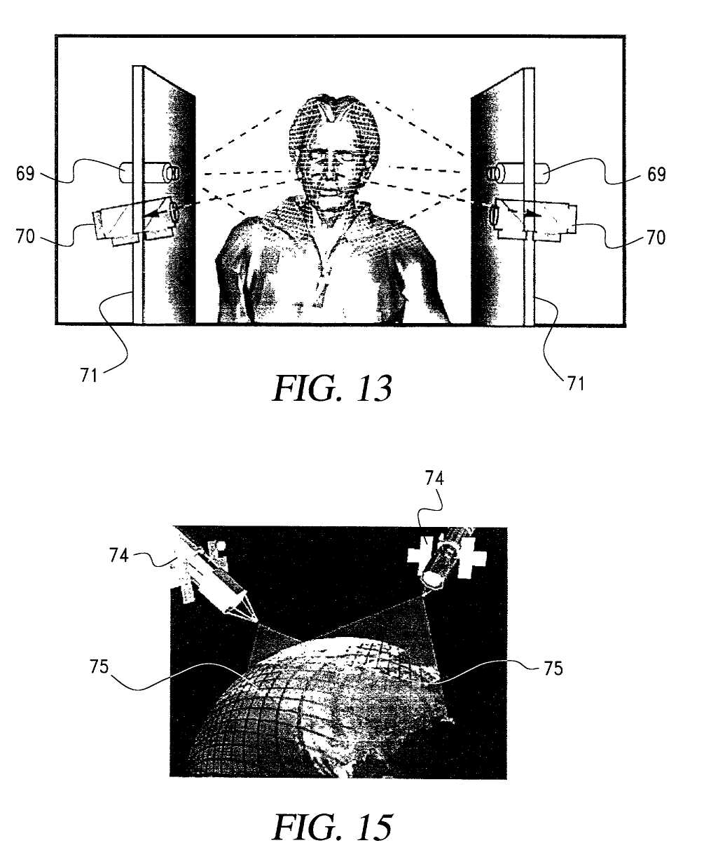

In the arrangement illustrated in FIG. 12, projectors 65 and receivers 66 corresponding to those illustrated in FIG. 10 are arranged in the front and rear bulkheads 67 of the cabin of a passenger airplane 68, while in the arrangement illustrated in FIG. 13, projectors 69 and receivers 70 corresponding to those illustrated in FIG. 11 are positioned in the walls 71 of a walk-through metal detector.

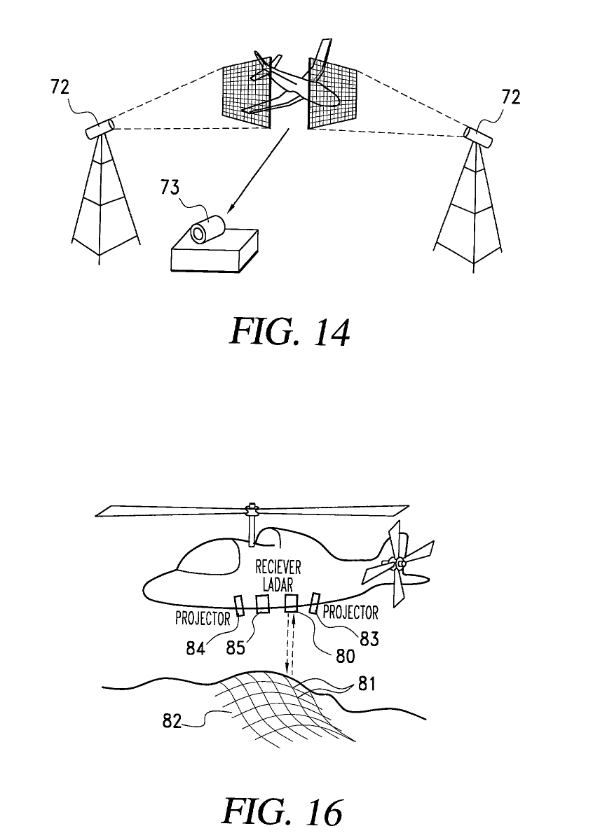

FIG. 14 shows a tracking or targeting system utilizing tower mounted projectors 72 and a central receiver 73 corresponding to the arrangement of FIGS. 10 and 12, while FIG. 15 shows a satellite mounted system corresponding to the arrangement shown in FIGS. 11 and 13, with separate receivers 74 for each projector 75. The satellite-based system of FIG. 15 could be used as part of an antiballistic missile defense system, to track cloud formations, for mapping, or for a variety of other scientific and military purposes.

Finally, as shown in FIG. 16, distance to the subject and contours of the subject may be determined by using a ladar range finder 80, or an equivalent range-finding device such as a conventional radio frequency radar transceiver, or a sonar device, focused on one or more reference points 81 on one or more grids 82 projected by projectors 83,84 and captured by receiver 85. The reference points may be hash marks or intersections between lines of the grid or grids. Once the distance to one point on the grid is known, the distance to all other points on the grid can also be determined without further scanning based on curvature of the grid around three-dimensional features. This eliminates or reduces scanning requirements for the ladar system, increasing speed and reducing processing overhead.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

I claim:

1. A system for capturing stereoscopic images and related data in a format that facilitates interpretation of the images and data by a human viewer or processing by a computer or other electronic processing device, comprising:
a first projector arranged to project a first two-dimensional pattern onto a three-dimensional subject, wherein a frequency of light forming said first two-dimensional pattern is different than a frequency of light illuminating said subject;
a receiver arranged to optically separate an image of said first two-dimensional pattern from an image of said three-dimensional subject based on said different frequencies of said light forming said first two-dimensional pattern and said light illuminating said subject.

2. A system as claimed in claim 1, wherein said first two-dimensional pattern is a grid.

3. A system as claimed in claim 1, wherein said light forming said first two-dimensional pattern is infrared light and said light illuminating said subject is visible light.

4. A system as claimed in claim 1, further comprising a second projector, said second projector being arranged to project a second two-dimensional pattern onto said subject from a different angle than said first projector, and said second two-dimensional pattern having a different frequency than said light forming said first two-dimensional pattern.

5. A system as claimed in claim 4, further comprising a second receiver arranged to optically separate an image of said second two-dimensional pattern from an image of said three-dimensional subject based on said different frequencies of said light forming said second two-dimensional pattern and said light illuminating said subject.

6. A system as claimed in claim 4, wherein said receiver is further arranged to optically separate an image of said second two-dimensional pattern from said image of said first two-dimensional pattern.

7. A system as claimed in claim 6, wherein said receiver includes a pair of beam splitters, one of which is arranged to separate said image of said first two-dimensional pattern from said image of said subject, and the second of which is arranged to separate said image of said second two-dimensional pattern from said image of said first two-dimensional pattern.

8. A system as claimed in claim 1, wherein said receiver includes a beam splitter arranged to separate said image of said first two-dimensional pattern from said image of said subject.

9. A system as claimed in claim 1, further comprising a second projector arranged to project a second two-dimensional pattern onto said subject, at least one of said projectors having an adjustable orientation such that alignment of said first and second two-dimensional patterns enables a distance to said subject to be determined.

10. A system as claimed in claim 9, wherein at least one of said projectors is arranged to project a hash mark onto a corresponding one of said grids in order to provide a reference for alignment of said grids.

11. A system as claimed in claim 1, further comprising a range-finding device arranged to determine a distance to from said receiver or projector to said subject.

12. A system as claimed in claim 11, wherein said range-finding device is a laser range-finding device.

13. A system as claimed in claim 11, wherein said range-finding device is arranged to determine a distance to at least one discrete point on said two-dimensional pattern.

14. A system as claimed in claim 13, wherein said at least one discrete point is a hash mark.

15. A system as claimed in claim 13, wherein said at least one discrete point is an intersection of lines in a two-dimensional grid.

16. An airline security system, comprising:
first and second projectors arranged to project a pair of infrared grids onto a person within an airport or airplane;
at least one receiver arranged to separate said images of infrared grids from a visible light image of said person, and to separate said images of said infrared grids from each other for separate processing.

17. A tracking, target acquisition, or guidance system, comprising:
first and second projectors arranged to project a pair of two-dimensional grids onto a moving object and to move in order to track the object;
at least one receiver arranged to separate images of said grids from an image of said object based on different wavelengths of light illuminating said object and light forming said grids.

18. A system as claimed in claim 17, wherein said projectors are further arranged to cause said grids to align, thereby determining a distance to said object.

19. A system as claimed in claim 17, further comprising a range-finding device arranged to determine a distance to at least one predetermined point on at least one of said grids.

20. A system as claimed in claim 17, wherein said range-finding device is a laser range-finding device.

21. A system as claimed in claim 20, wherein said predetermined point is a hash mark.

22. A system as claimed in claim 20, wherein said predetermined point is an intersection of two lines of one of said grids.

23. A method for capturing stereoscopic images and related data in a format that facilitates interpretation of the images and data by a human viewer or processing by a computer or other electronic processing device, comprising the steps of:
projecting a first two-dimensional pattern onto a three-dimensional subject, wherein a frequency of light forming said first two-dimensional pattern is different than a frequency of light illuminating said subject;
optically separating an image of said first two-dimensional pattern from an image of said three-dimensional subject based on said different frequencies of said light forming said first two-dimensional pattern and said light illuminating said subject.

24. A method as claimed in claim 23, further comprising the step of projecting a second two-dimensional pattern onto said subject from a different angle than an angle at which said first two-dimensional pattern is projected, and said second two-dimensional pattern having a different frequency than said light forming said first two-dimensional pattern.

25. A method as claimed in claim 23, further comprising the step of aligning first and second said two-dimensional patterns to determine a distance to said subject.

26. A method as claimed in claim 23, further comprising the step of using a range finder to determine a distance to a predetermined point on said two-dimensional pattern.

27. A method as claimed in claim 26, wherein said range finder is a laser range-finding device.
